(19) United States
(12) Patent Application Publication
(10) Pub. No.: US 2014/0301370 A1
(43) Pub. Date: Oct. 9, 2014

(54) WIRELESS TELECOMMUNICATION NETWORK

(71) Applicant: Sharp Kabushiki Kaisha, Osaka-shi, Osaka (JP)

(72) Inventor: Sivapathalingham Sivavakeesar, Bracknell (GB)

(73) Assignee: Sharp Kabushiki Kaisha, Osaka-shi, Osaka (JP)

(21) Appl. No.: 14/353,799

(22) PCT Filed: Nov. 13, 2012
(86) PCT No.: PCT/JP2012/007281

§ 371 Date: Apr. 24, 2014

(30) Foreign Application Priority Data
Nov. 24, 2011 (GB) 1120290.0

(51) Int. Cl. H04W 36/00; H04B 7/15

(52) U.S. Cl. CPC H04W 36/0005; H04B 7/15
USPC 370/331

(57) ABSTRACT

A wireless communication network comprising a first base station, a second base station and a relay node. The relay node is one of a plurality of types (eg type 1, type 1a or type 1b) present within the network, and the relay node is connected to the first base station. When handover is required, the first base station sends a handover request to the second base station of information pertaining to the handover, including information regarding the relay node's type and/or radio capabilities.

### TECHNICAL FIELD

The present invention relates to a relay node, and a wireless telecommunication system including same. Particularly, the present invention relates to the C-plane (control plane) handling of a Mobile Relay Handover needed for out-band, in-band relay types with or without resource partitioning as applicable in the context of 3GPP Long Term Evolution (LTE)-Advanced.

### BACKGROUND ART

The first release of the LTE was referred to as release-8, and provided a peak rate of 300 Mbps, a radio network delay of less than 5 ms, an increase in spectrum efficiency and new architecture to reduce cost and simplify operation.

LTE-A or LTE Advanced is currently being standardized by the 3GPP as an enhancement of LTE. LTE mobile communication systems are expected to be deployed from 2010 onwards as a natural evolution of GSM and UMTS.

Being defined as 3.9G (3G+) technology, LTE does not meet the requirements for 4G, also called IMT Advanced, that has requirements such as peak data rates up to 1 Gbps.

In April 2008, 3GPP agreed to the plans for future work on Long Term Evolution (LTE). A first set of 3GPP requirements on LTE Advanced was approved in June 2008. The standard calls for a peak data rate of 1 Gbps and also targets faster switching between power states and improved performance at the cell edge.

Further details may be found at www.3gpp.com.

### CITATION LIST

### Non Patent Literature

www.3gpp.com
LTE-A release 10 (Rel-10) is the current release.

Relaying is considered as an economical way of extending the coverage, improving the cell-edge throughput and system capacity. FIG. 1 shows a simplified example of part of the LTE network. There is provided a base station, typically called an evolved node B (eNB) 10, a relay node (RN) 14 and a plurality of user equipment (UE) 18 and 20. A controlling eNB is sometimes referred to as a donor eNB, or D-eNB. A D-eNB controls network traffic within a domain (containing one or more cells). Said domain may include a plurality of further nodes. Domains located geographically next to one another may be termed neighbouring domains.

The D-eNB is typically wired to the core network 16. This connection is often termed the eNB's backhaul. The D-eNB can communicate wirelessly with UE 18. This connection is termed the access link. The D-eNB 10 can also communicate with UE 20 via RN 14. The RN 14 thus has an access link to UE 20 and a backhaul link to the D-eNB. The access link is via the Uu interface, whilst the backhaul link is via the Un interface.

A communication from a UE or node back towards the core network (i.e. UE to RN or D-eNB) is called the uplink (sometimes abbreviated to UL), whereas communication in the opposite direction (i.e. D-eNB or RN to UE) is called the downlink (sometimes abbreviated to DL). Thus, the communication from the RN to the D-eNB is the downlink in respect to the RN, whilst the reciprocal communication is the uplink.

In LTE-A, relays are broadly defined in two categories: type 1 and type 2. Type 1 relay nodes have their own PCI (Physical Cell ID) and are operable to transmit its common channel/signals. UEs receive scheduling information and HARQ feedback directly from the relay node. It is also possible for type 1 relay nodes to appear differently to eNBs to allow for further performance enhancement.

The primary proposal in LTE-A is to predominantly use Type 1 relays in next generation networks. Type 1 relays may be considered as containing the functionalities of both an eNB (control node) and UE (user equipment), depending on how its functionalities are viewed. Thus, in the backhaul link the relay behaves like a UE (which is operated by the functionality of a UE), whereas in the access link it behaves like an eNB (which is operated by the functionality of an eNB). Or, put another way, the D-eNB sees the relay as a UE, whereas the UE sees the relay as an ordinary eNB. Type 1 relays are further categorized into Type 1, Type 1a and Type 1b. Within the Rel-10 timeframe, RNs that are of type-1, 1a and 1b are predominantly considered.

The RN connects to the D-eNB via the Un interface using the same radio protocols and procedures as a UE connecting to an eNB. In terms of the RN's capability to isolate outgoing and incoming signals, Rel-10 RN is fundamentally classified into:

Type 1 (In band) Relaying—in which case the Un interface shares the same carrier frequency with RN-UE link and it is not capable of isolating the outgoing and incoming signals. In this case, isolation is performed in the time domain. Some of the subframes are reserved for the backhaul link and cannot be used for the access link operation;

Type 1a (Out band) Relaying—in which case the Un interface does not operate in the same carrier frequency as RN-UE link and subframe configuration is not required for the communication over Un interface. In this case, isolation is performed in the frequency domain;

Type 1b (in band with antenna isolation)—Relay operation happens in-band, but isolation is not performed in the time domain, but via adequate antenna configuration.

In-band relay operation is more complex, since isolation in the time domain needs sophisticated configuration of the Un interface. In contrast, out-band relay operation is more straightforward, since it only requires adequate frequency planning. Typically, the backhaul link gets assigned the lower carrier frequency, such that it suffers less from distance-dependent attenuation and can be located close to the edge of the macro cell. Hence, no additional functionality beyond Rel-8 is required, i.e., the Un interface behaves in the same way as a legacy Uu link.

In-band relaying operation without adequate antenna isolation requires reservation of certain subframes for the backhaul link. For the uplink direction, (isolation of UE to RN transmission from RN to D-eNB transmission) the blocking of UE transmissions is straightforward, since the RN performs the uplink grant scheduling itself and therefore has full control over when it wants to transmit and receive data.

In the downlink direction, i.e., isolation of D-eNB to RN transmission from RN to UE transmission, the situation is more difficult. This is partly because the UEs attached to the RN typically expect at least control data, i.e., the Physical Downlink Control Channel (PDCCH) in every subframe. In order to create “gaps” at certain subframes, an already existing mechanism in LTE, which has originally been devised for multicast transmission in LTE, is re-used. Accordingly, via RRC signalling from the relay node, certain downlink subframes within a period of 1 or 4 radio frames (corresponding to an interval of 10 or 40 ms, respectively), can be declared as MBSFN subframes. This informs the attached UEs that they should not expect any transmission to them in these subframes, i.e., should not listen at all.

As a result, for the relay operation, the D-eNB needs to ascertain whether Un subframe configuration/reconfiguration (i.e., RN requiring one type of Un resource partitioning) should be applied on Un interface or not for a given RN. In other words, subframes need to be configured such that half-duplex operation can be ensured in the case of Type 1 relays. The RRC layer (the radio resource control) of the Un interface has functionality to configure or reconfigure and activate specific subframe configurations (e.g. DL subframe configuration) for transmissions between an RN and a D-eNB, for RNs of Type 1. This means that the D-eNB needs to be aware of RN's type before initiating the RRC signalling for such configurations. The RN applies the configuration immediately upon reception.

To aid understanding of the present arrangement, further detail on resource partitioning is provided. Type A relays are in band that operate in half-duplex mode—i.e., when the access link is operational the backhaul cannot operate and vice-versa. Main downlink transmission occurs on the backhaul on MBSFN sub-frames. MBSFN sub-frames cannot be configured in the downlink on sub-frames 0, 4, 5 and 9: this sub-frame configuration concerns making the backhaul and access link function without interference.

Hence, some type of resource partitioning is paramount for type-1 relays. Time-frequency resources for eNB-RN transmissions are achieved by time multiplexing eNB-RN and RN-UE transmissions. Subframes during which eNB-RN transmission may take place are configured by higher layers. Downlink subframes configured for eNB-to-RN transmission shall be configured as MBSFN subframes by the relay node. eNB-to-RN transmissions occur in downlink subframes and RN-to-eNB transmissions occur in uplink subframes. For frame structure type 1, eNB-to-RN and RN-to-UE transmissions occur in the downlink frequency band, while RN-to-eNB and UE-to-RN transmissions occur in the uplink frequency band. (Reference: 3GPP TS 36.216)

### SUMMARY OF INVENTION

### Technical Problem

In summary:

Use of MBSFN subframes are needed to ensure half-duplex operation in the time-domain;

Downlink subframes configured for eNB-to-RN transmission shall be configured as MBSFN subframes by the relay node;

Relay-to-D-eNB transmissions can be facilitated by not allowing any UE-to-relay transmissions in some subframes;

Relay-to-UE communication using non-MBSFN subframes;

D-eNB-to-relay communication using MBSFN subframes; and

Subframes during which eNB-RN transmission may take place are configured by higher layers.

Part of the core network includes the mobility management entity (MME). Generally, a UE is associated to one particular MME for its communications. This creates a context in this MME for the UE. This particular MME is selected by NAS Node Selection Function (NNSF) in the first eNB from which the UE enters the network. Whenever a UE becomes active, the MME provides the UE context information to the eNB. A relay-MME works in a similar manner, but relates to RNs, rather than UEs.

The present invention seeks advancements to relaying technology, specifically with relation to how mobile relaying can improve network performance.

### SUMMARY OF THE INVENTION

Relay types (especially Type 1 and 1a) defined by the 3GPP are tied to their capability in terms of the number of transceivers a relay node is equipped with, their operating frequency range, and whether the relay node can support full/half-duplex operation. If a relay node (RN) comprises more than one transceiver it will have the capability to operate in different frequency bands simultaneously on both the access link and the backhaul link. However, there is a possibility for a relay node to be Type-1 when it is attached to one D-eNB (say, a source D-eNB) but operate in Type-1a type/mode when it is attached to a different D-eNB (say, Target D-eNB). This is because different nodes (D-eNBs and RNs) operate with different frequency spectrums, and as such a given RN may be regarded by one eNB as being one particular type, but seen by a different eNB to be a different type. The main occasions when this will occur are between type 1 and type 1a RNs.

In order to accommodate this situation, the present invention seeks to introduce efficiencies and advancements within the network.

### Solution to Problem

According to the present invention there is provided a wireless communication network comprising:
a first base station;
a second base station; and
a relay node, said relay node being one of a plurality of types present within the network,
said relay node is connected to the first base station,
wherein,
when handover is required, said first base station sends a handover request to the second base station of information pertaining to the handover, including information regarding the relay node's type.

According to the present invention there is provided a relay node operable to function in a wireless communications network, said relay node being one of a plurality of types possible within said wireless communications network, wherein the relay node is operable to handover its backhaul link from a first base station to a second base station, wherein information regarding the relay node's type is communicated to the second base station.

According to the present invention there is provided a base station operable to function within a wireless communications network, said base station comprising a wireless link to a relay node, said relay node being one type within a plurality of types with the wireless communications network, wherein said base station is operable to handover the wireless link to a further base station, wherein the handover includes details of the relay node's type.

According to a second aspect of the present invention there is provided a wireless telecommunications network comprising:
a mobile relay node of one of a plurality of types used within the wireless telecommunications network; and
a base station,
   wherein, when the relay node has cause to attach to the wireless telecommunications network, either 1) it communicates its type to said base station, or 2) the core network communicates the relay node's type to the base station.

In order that the present invention be more readily understood, specific embodiments will now be described with reference with the accompanying drawings.

### BRIEF DESCRIPTION OF DRAWINGS

FIG. 1 shows an example of LTE-A network architecture incorporating a static relay.

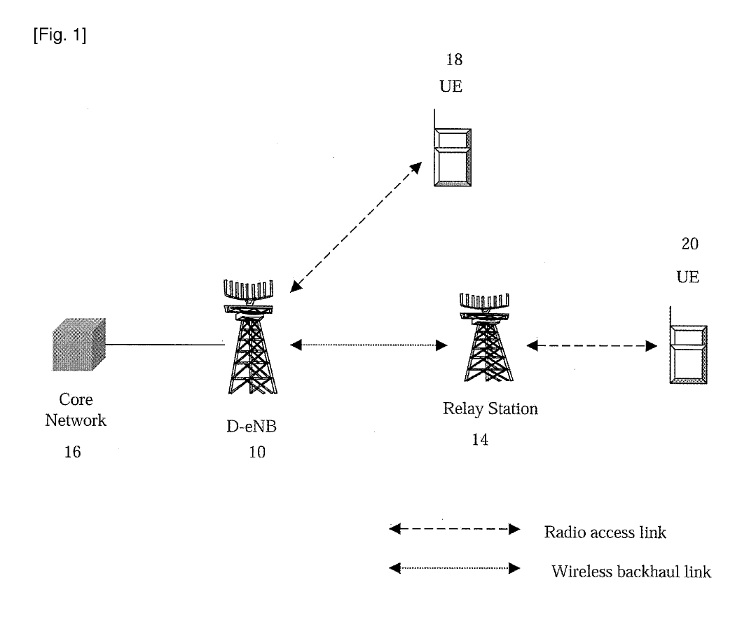

FIG. 2 shows an example of LTE-A network architecture incorporating a mobile relay.

FIG. 3 is a diagram showing intra-MME/serving gateway handover procedure as applicable to the present arrangement.

FIG. 4 is a diagram showing a signalling diagram showing a handover procedure as applicable to the present arrangement.

### DESCRIPTION OF EMBODIMENTS

### Specific Embodiments

The present invention is primarily concerned with mobile relay attachment and handover within the LTE-A wireless networks. However, the present arrangement is applicable to static relay nodes when said static relay node is subject to a handover between base stations for load balancing purposes. In LTE networks, relay nodes may be passed from one base station to a second base station. This is termed a handover. Typically, the first base station is termed a source D-eNB, whilst the second base station is termed a target D-eNB.

The sections below give information on relay node capabilities required for configuration. Given that LTE-A networks can comprise multiple types of relay nodes (e.g. type 1, type 1a, type 1b, type 2, repeaters) it is important when a relay node (RN) attaches to D-eNB or is handed over from one D-eNB to another that the relevant D-eNB can readily ascertain the RN's type. Different relay nodes may have different capabilities which effect the way they operate within the network. Relevant information on RN capability includes:

Carrier aggregation capabilities on backhaul link (UE-like functionality) in downlink and uplink;

Relay node's eNB-like functionality capabilities to operate on multiple carriers; and

Supported relay node types.

In case of handing over a relay node, such details as the given RN carrier aggregation capabilities on the RN's backhaul link can be notified by a source D-eNB to a target D-eNB in the Handover Request command. By means of this signalling a source D-eNB can inform a target D-eNB as to how many component carriers the RN is capable of operating in the downlink and the uplink. Alternatively the information can be provided to the D-eNB or to a target D-eNB from the MME serving the RN by means of S1 signalling. This information is used by a target D-eNB for optimum carrier configuration for the backhaul link. Resource Partitioning may be decided individually for each component carrier, if needed. The passed on information passed on may also contain a given RN's eNB-like capability details on supported multi-carrier operation schemes—it may include:

Supported frequency bands;

Maximum number of supported downlink and uplink component carriers; and

Support of discontinuous and multi-band carrier aggregation.

High speed public transportation is being deployed worldwide at a rapid pace. It is therefore desirable to include relay nodes (RNs) onto such transportation. Such RNs are typically termed mobile relays. Indeed, mobile relays have recently started drawing the attention of the 3gpp because of their ability to minimize or completely avoid the high and bursty signalling load at the time of group mobility. In such a situation a mobile relay being mounted on a vehicle can perform a group mobility instead of individual mobility procedures for every user equipment (UE). In other words, UEs connected to a mobile relay do not have to individually handover between D-eNBs as they pass through different domains; the mobile relay can maintain connection with each UE and handover its backhaul link between D-eNBs. Although the actual relay type(s) for mobile relays is not finalized by the 3GPP, it is acknowledged that it would be advantageous if they are equipped with advanced antenna systems. Hence their spectral efficiency would be superior to that of a normal UE. Separate antennas for the backhaul and the access link can improve the performance. In the present arrangement it is assumed here that mobile relays will also be categorized into different types—it can be in line with the existing categorization as outlined in the previous paragraphs or can support entirely new categorization. However, it is very likely that the RNs may be either in-band or out-band.

It is not the ambit of the present application to devise optimal architecture for mobile relays (or mobile RNs). However, it is evident from the above description that it is important for a D-eNB to decide on the relay node type at the time of relay attachment or relay handover, and the present invention seeks advantages, improvements and efficiencies in this area.

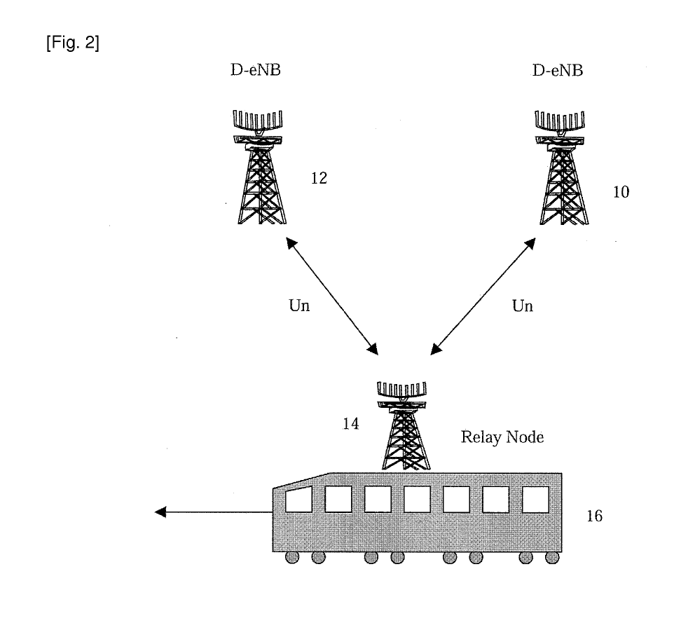

FIG. 2 shows an example of LTE architecture with a mobile relay. In the present case mobile RN 14 is mounted on train 16. As will be appreciated, trains travel at high speeds, and as such will pass through multiple domains (or cells), and as such have to interact with multiple D-eNBs 10, 12. In the case shown in FIG. 2, RN 14 is connected to D-eNB 10, but as it moves away from this node and towards D-eNB 12, it will becomes necessary for the RN to be handed over from D-eNB 10 to D-eNB 12.

Thus, a mobile RN handover is a common occurrence, and consideration has to be made for a mechanism for a target D-eNB 12 to ascertain the relay type before it can decide whether or not it can support the relay to be handed over. In case it can support the mobile RN 14, the target D-eNB 12 has to quickly decide on whether any type of resource partitioning is needed (e.g., in the form of subframe configuration). In the case of Rel-10, it is reasonable to have a pre-configured RN-D-eNB pair (pre-configured pairs of D-eNB-RN are for static RNs that will always be in communication with the same D-eNB, and as such the subframes on the RNs backhaul will always be configured) because of the limited deployment of relays by the network operators. This means that the relay type remains to be static for a given RN-D-eNB pair.

In the case of mobile RNs, or fixed relays that are allowed to be attached to one of many neighbouring D-eNBs, such pre-configuration will not work. This is because a mobile relay will be handed over to any eNB on its way that operates in the capacity of a D-eNB, or a fixed relay may be forced to change its attachment due to load balancing or other reasons—under these circumstances the operating frequency bands may be different. Under such circumstances, it is preferable for a D-eNB, in case of a mobile relay attachment or for a target D-eNB in case of a relay handover, to configure subframes or partition resources dynamically, depending on the mobile relay type and/or its capabilities in terms of frequency-bands or radio access technologies (RATs) being supported, full-/half-duplex operation being possibly, carrier-aggregation support and the like. This requires that a target D-eNB needs to be notified of the mobile relay type and/or its capabilities as mentioned above. The present arrangement proposes a methodology to achieve this while making sure that it is in conformity with existing network protocols.

For attachment of RNs to a D-eNB, there are two methods to inform the type of a mobile relay to any possible eNB that has the D-eNB capabilities. The first is to let the RN 14 inform its relay type to the D-eNB 12 using a modified UE capability container (a modified UE capability container is part of the UE capability transfer procedure. The E-UTRAN can indicate for each RAT whether it wants to receive associated capabilities of UE. A UE provides the requested capabilities using a separate container for each RAT). In the present case the RN would use a RN capability container.

The second option is for the core network (e.g., OAM, EPC, Relay-MME) to pass the RN's operating frequencies on to the D-eNB 12 at the time of mobile relay attachment or relay handover. The core network can include the type in the RN/UE context as the establishment and the modification of UE/RN context is initiated by an MME—a Rel-8/9 UE context normally includes E-RAB quality of service and transport parameters, security context (cipher key), handover restriction, trace activation, CSFB, SRVCC ops status, UE radio and security capabilities. In case the mobile RN is robust in terms of supporting any relay type and/or any operating frequencies, the D-eNB 12 will configure the mobile RN 14 depending on its capabilities, and the extent of support that it can provide.

Thus, in the present arrangement there is provided a wireless telecommunications network that includes a mobile RN of one of a plurality of types (ie type 1, type 1a, type 1b etc) and a base station. When the RN has cause to attach to the wireless telecommunications network, either 1) it communicates its type to the D-eNB (base station), or 2) the core network communicates the RN's type to the D-eNB (base station).

For mobile relay handover, it is appropriate for the Source D-eNB 10 to pass the relay type onto the target D-eNB 12 with/without additional details such as different radio access technologies (RATS) being supported by a given relay and whether a given RN can operate in half-duplex or full-duplex mode in the frequency domain, time domain or space domain under each RAT, and the frequency bands the RN can support under each RAT including how many component carriers the RN is capable of operating in the downlink and the uplink of the backhaul, and the RN's eNB-like capability details on supported multi-carrier operation on the backhaul. The appropriate timing for such an operation to take place is when the Handover Request command is issued. Hence, the type of the mobile relay and/or its capability details can be included as part of Handover Request parameters and notified to the target D-eNB 12. The above concepts are also equally applicable to fixed (static) relays, given that a fixed relay may be handed over to a neighbouring D-eNB due to load-balancing purposes.

Thus, the present arrangement relates to a wireless communication network, such as an LTE-A network. The network includes a first base station and a second base station, which are typically eNBs that are capable of supporting relays. The network also comprises a relay node being one of a plurality of types present within the network (e.g. type 1, type 1a, type 1b or type 2). The relay node is connected to the first base station such that, when handover a is required, said first base station sends a handover request to the second base station of information pertaining to the handover, including information regarding the relay node's type and/or a given relay's capability details. The arrangement is particularly relevant to mobile relays, due to their frequent need to pass between base stations (D-eNBs).

The first base station/eNB is operable to send to the second base station/eNB a relay node capability container for each RAT being supported by a relay in the handover request. This mechanism is similar to a source eNB sending a target D-eNB a UE capability container in a UE handover. Alternatively, the second base station can request the relay node capability container from the first base station on demand.

Another possibility for a target D-eNB (second base station) is to acquire the relay node capability container from the core network. Thus second base station is operable to demand one or a plurality of radio capability details of the RN, such as different radio access technologies (RATS) being supported by the relay node, and whether the RN can operate in half-duplex or full-duplex mode in the frequency domain, time domain or space domain under each RAT, and the frequency bands the RN can support under each RAT, including how many component carriers the RN is capable of operating in the downlink and the uplink of the backhaul, and the RN's eNB-like capability details on supported multi-carrier operation on the backhaul from the core network (e.g., OAM, EPC, Relay-MME).

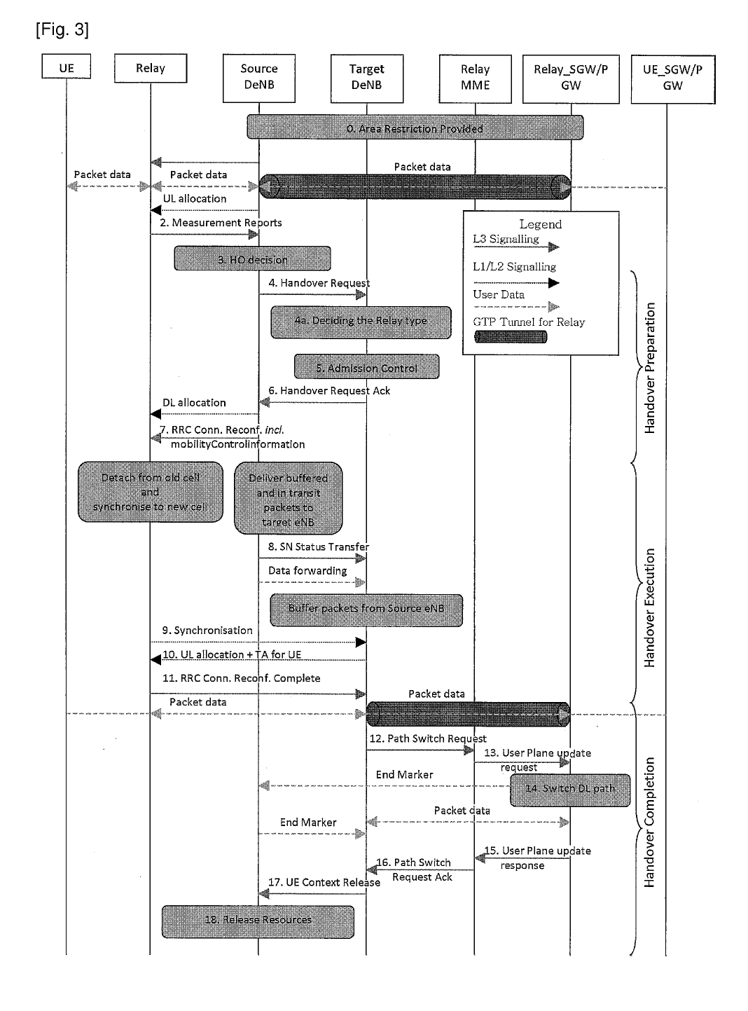

The above aspects are now discussed further in relation to FIG. 3.

Below is a more detailed description of the intra-MME/Serving Gateway handover procedure as applicable to relay architecture A (Alt1) that is inline with the 3GPP TS 36.300. Further details about different relay architectures may be found in the present applicant's application number GB 2475906. The numbering of each step refers to the steps illustrated in FIG. 3. Where possible, wording used in TS 36300 has been maintained.
0 The UE/RN context within the source D-eNB contains information regarding roaming restrictions which were provided either at connection establishment or at the last TA update.
1 The source D-eNB configures the UE/RN measurement procedures according to the area restriction information. Measurements provided by the source D-eNB may assist the function controlling the UE's/RN's connection mobility.
2 The UE/RN is triggered to send MEASUREMENT REPORT by the rules set by i.e. system information, specification etc.
3 The source D-eNB makes decision based on MEASUREMENT REPORT and RRM information to hand off the UE/RN.
4 The source D-eNB issues a HANDOVER REQUEST message to the target D-eNB passing necessary information to prepare the handover at the target side (relay type and/or a capability container including details such as different radio access technologies (RATs) being supported by a given relay and whether a given RN can operate in half-duplex or full-duplex mode in the frequency domain, time domain or space domain under each RAT, and the frequency bands the RN can support under each RAT including how many component carriers the RN is capable of operating in the downlink and the uplink of the backhaul, and the RN's eNB-like capability details on supported multi-carrier operation on the backhaul, UE X2 signalling context reference at source eNB, UE S1 EPC signalling context reference, target cell ID, KeNB*, RRC context including the C-RNTI of the UE/RN in the source D-eNB, AS-configuration, E-RAB context and physical layer ID of the source cell+short MAC-I for possible RLF recovery). UE/RN X2 or UE/RN S1 signalling references enable the target D-eNB to address the source eNB and the EPC. The E-RAB context includes necessary RNL and TNL addressing information, and QoS profiles of the E-RABs.
4a. On receiving the HO Request along with the information as to the type along with a radio capabilities of relay node being handed over, the target D-eNB will examine the relay's capability based on the information being passed on in the capability container and deciding its supported relay type.
5. Admission Control may be performed by the target D-eNB dependent on the received RN type and its resource configuration details gathered as part of 4a/b stage above and E-RAB QoS information to increase the likelihood of a successful HO, if the resources can be granted by target D-eNB. The target D-eNB configures the required resources according to the received RN type and E-RAB QoS information and reserves a C-RNTI and optionally a RACH preamble. The AS-configuration to be used in the target cell can either be specified independently (i.e. an “establishment”) or as a delta compared to the AS-configuration used in the source cell (i.e. a “reconfiguration”).
6 The target D-eNB prepares HO with L1/L2 and sends the HANDOVER REQUEST ACKNOWLEDGE to the source D-eNB. The HANDOVER REQUEST ACKNOWLEDGE message includes a transparent container to be sent to the UE/RN as an RRC message to perform the handover. The container includes a new C-RNTI, target D-eNB security algorithm identifiers for the selected security algorithms, may include a dedicated RACH preamble, control channel configuration and other control information that is normally carried by a MIB/SIBs, and possibly some other parameters i.e. access parameters, SIBs, etc. The HANDOVER REQUEST ACKNOWLEDGE message may also include RNL/TNL information for the forwarding tunnels, if necessary.

NOTE: As soon as the source D-eNB receives the HANDOVER REQUEST ACKNOWLEDGE, or as soon as the transmission of the handover command is initiated in the downlink, data forwarding may be initiated.

Steps 7 to 16 provide means to avoid data loss during HO and are further detailed in 10.1.2.1.2 and 10.1.2.3 of 3GPP TS 36.300, (and are incorporated herein by reference).

In case of intra-E-UTRAN mobility involving EPC relocation, the relay type can be included in the Forward Relocation Request being originated by Source Relay-MME destined to Target Relay-MME.

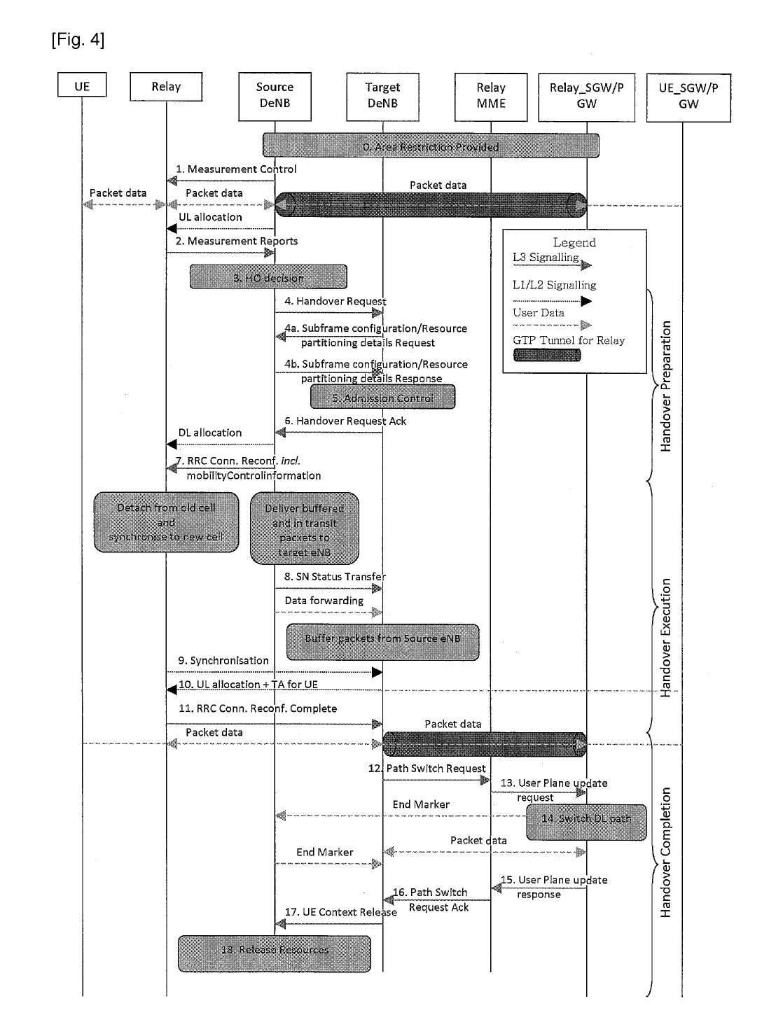

The arrangement illustrated in FIG. 4 is related to that shown in FIG. 3, except that the information regarding relay type and the RN capability container information are not passed from the source D-eNB to the source D-eNB in the initial handover request. Instead, required information is fetched by the target D-eNB on demand in the following two steps:

4a. On receiving the HO Request along with the information as to the type of relay node being handed over, the target D-eNB issue a new message to acquire further capability details of the RN either from a source D-eNB (shown in FIG. 4) or from the core/EPC (not shown) once the relay identifier is known. These capability details will be non-exhaustive in nature and will preferably include one or plurality of the following: Un subframe configuration/reconfiguration (or resource partitioning) details in case the node is of type 1 relay, or some other details pertaining to resource configuration in case it is of a new type and/or different radio access technologies (RATs) being supported by a given relay and whether a given RN can operate in half-duplex or full-duplex mode in the frequency domain, time domain or space domain under each RAT, and the frequency bands the RN can support under each RAT including how many component carriers the RN is capable of operating in the downlink and the uplink of the backhaul, and the RN's eNB-like capability details on supported multi-carrier operation on the backhaul.

4b. On receiving the request to acquire resource configuration details, either the source D-eNB or the core network (e.g., EPC) will supply the RN capability container according to the request.

In other words, the system have to have the source D-eNB initially pass the relay type to the target D-eNB, and await a request from the target D-eNB for further information.

Whilst the above embodiments have generally been described with reference to mobile relays, it is stresses again that it will be appreciated that the above concepts are equally applicable to fixed (static) relays given that a fixed relay may be handed over to a neighbouring D-eNB due to load-balancing purposes.

It is to be appreciated that the above described embodiments are provided for understanding only, and that many modifications and variations are possible within the scope of the present invention.

According to the present invention there is provided a wireless communication network comprising:
a first base station;
a second base station; and
a relay node, said relay node being one of a plurality of types present within the network,
said relay node is connected to the first base station,
wherein,
when handover is required, said first base station sends a handover request to the second base station of information pertaining to the handover, including information regarding the relay node's type.

It is preferred that the first base station and the second base station are evolved nodeBs—typically termed eNBs. It is particularly desirable that the network is an LTE-A network. In a handover situation in the present arrangement, the first eNB (base station) is typically termed the source D-eNB, whilst the second eNB (base station) is typically termed the target D-eNB.

In addition to relay type, the first base station may include an RN capability container in the Handover Request that indicates different radio access technologies (RATs) being supported by the RN and whether the RN can operate in half-duplex or full-duplex mode in the frequency domain, time domain or space domain under each RAT, and the frequency bands the RN can support under each RAT including how many component carriers the RN is capable of operating in the downlink and the uplink of the backhaul, and the RN's eNB-like capability details on supported multi-carrier operation on the backhaul. This will allow a target D-eNB to decide whether it can accommodate the RN being handed over while allowing either it to continue operating in the same relay type or it to take a different operating relay type.

Preferably the second base station, after receipt of the handover request, requests the first base station to send a relay node capability container.

It is preferred that, on receipt of the handover request, the second base station (target D-eNB) issues a request to the first base station (source D-eNB) to acquire subframe configuration/reconfiguration and/or resource partitioning details.

Particularly, it is preferred that the second base station (target D-eNB) issues a request to the first base station (source D-eNB) to acquire subframe configuration/reconfiguration and/or resource partitioning details if the relay node is a type 1 relay.

In alternative embodiments, the wireless communications network further comprises a core network, and after receipt of the handover request, the second base station requests the core network to supply a relay node capability container. Particularly, on receipt of the handover request the second base station (target D-eNB) may issue a request to the core network to acquire subframe configuration/reconfiguration and/or resource partitioning details and/or an RN capability container to indicate different radio access technologies (RATs) being supported by the RN, and whether the RN can operate in half-duplex or full-duplex mode in the frequency domain, time domain or space domain under each RAT, and the frequency bands the RN can support under each RAT including how many component carriers the RN is capable of operating in the downlink and the uplink of the backhaul, and the RN's eNB-like capability details on supported multi-carrier operation on the backhaul.

Preferably the relay node is a mobile relay node. It is particularly preferred that the mobile relay node is mounted upon a public transport vehicle, with it being specifically desirable for the mobile relay node to be mounted upon a train. However, it will be appreciated that the mobile relay may be mounted upon any vehicle

Preferably the relay node is of type 1, type 1a or type 1b. However, it will be appreciated that other relay types—such as type 2—are possible within the present arrangement.

The present invention also relates to a relay node operable to function within the above described wireless communication network, and also to a base station that may operate in the capacity of either the first base station or the second base station

According to a second aspect of the present invention there is provided a wireless telecommunications network comprising:
a mobile relay node of one of a plurality of types used within the wireless telecommunications network; and
a base station,
   wherein, when the relay node has cause to attach to the wireless telecommunications network, either 1) it communicates its type to said base station, or 2) the core network communicates the relay node's type to the base station.

The above aspect relates to relay attachment to a wireless network. In accordance with the first aspect, it is preferred that—individually or collectively—the network is an LTE network, the relay node is a mobile node and particularly of type 1, type 1a or type 1b, and the base stations are eNBs.

In order that the present invention be more readily understood, specific embodiments will now be described with reference with the accompanying drawings.

### INDUSTRIAL APPLICABILITY

The present arrangement is particularly relevant in LTE-A, although it may be applied for WiMAX (both IEEE 802.16e and IEEE 802.20) and Long range WiFi.

1-22. (canceled)

23. A wireless communication network comprising:
a first base station;
a second base station; and
a relay node, said relay node being one of a plurality of types present within the network,
said relay node is connected to the first base station,
wherein,
when handover is required, said first base station sends a handover request to the second base station of information pertaining to the handover, including information regarding the relay node's type.

24. A wireless communication network according to claim 23, wherein the relay node is a mobile relay node.

25. A wireless communication network according to claim 23, wherein the first base station and the second base station are evolved nodeBs (eNBs).

26. A wireless communication network according to claim 23, wherein the first base station sends a relay node capability container to the second base station in the handover request.

27. A wireless communication network according to claim 23, wherein the second base station, after receipt of the handover request, requests a relay node capability container from the first base station.

28. A wireless communication network according to claim 23, wherein the network comprises a core network, and after receipt of the handover request, the second base station requests the core network to supply a relay node capability container.

29. A wireless communication network according to claim 26, wherein the relay node capability container includes details of different radio access technologies (RATs) supported by the relay node.

30. A wireless communication network according to claim 26, wherein the relay node capability container indicates whether the relay node can operate in half-duplex or full-duplex mode in the frequency domain, time domain or space domain.

31. A wireless communication network according to claim 26, wherein the relay node capability container further indicates the frequency bands the relay node can support under each radio access technology (RAT), including the number of component carriers the relay node is capable of operating in a downlink and an uplink of a backhaul link.

32. A wireless communication network according to claim 26, wherein the relay node capability container further indicates a relay node's capability on supported multi-carrier operation on the backhaul link.

33. A wireless communication network according to claim 26, wherein the relay node capability container allows the second base station to determine whether or not it can accommodate the relay node while allowing the relay node to continue operating in the same relay type or the relay node to take a different operating relay type.

34. A wireless communication network according to claim 23, wherein the relay node is of type 1, type 1a or type 1b.

35. A wireless communication network according to claim 33, wherein on receipt of the handover request the second base station issues a request to the first base station so as to acquire subframe configuration/reconfiguration and/or resource partitioning details.

36. A wireless communication network according to claim 34, wherein the second base station issues a request to the first base station to acquire subframe configuration/reconfiguration and/or resource partitioning details if the relay node is a type 1 relay.

37. A wireless communication network according to claim 28, wherein on receipt of the handover request the second base station issues a request to the core network to acquire subframe configuration/reconfiguration and/or resource partitioning details and/or a relay node capability container to indicate different radio access technologies (RATs) being supported by the relay node, and whether the relay node can operate in half-duplex or full-duplex mode in the frequency domain, time domain or space domain under each RAT, and the frequency bands the relay node can support under each RAT including how many component carriers the relay node is capable of operating in the downlink and the uplink of the backhaul, and the relay node's eNB-like capability details on supported multi-carrier operation on the backhaul.

38. A relay node operable to function in the wireless communication system according to claim 23.

39. A base station operable to function as either the first base station or second base station in the wireless communication system according to claim 23.

40. A relay node operable to function in a wireless communications network, said relay node being one of a plurality of types possible within said wireless communications network, wherein the relay node is operable to handover its backhaul link from a first base station to a second base station, wherein information regarding the relay node's type is communicated to the second base station.

41. A base station operable to function within a wireless communications network, said base station comprising a wireless link to a relay node, said relay node being one type within a plurality of types with the wireless communications network, wherein said base station is operable to handover the wireless link to a further base station, wherein the handover includes details of the relay node's type.
